(19) United States
(12) Patent Application Publication
(10) Pub. No.: US 2025/0087864 A1
(43) Pub. Date: Mar. 13, 2025

(54) Power Storage Cell

(71) Applicant: TOYOTA JIDOSHA KABUSHIKI KAISHA, Toyota-shi Aichi-ken (JP)

(72) Inventors: Takeru HARA, Toyota-shi Aichi-ken (JP); Masato ONO, Nagoya-shi Aichi-ken (JP); Satoshi MORIYAMA, Nagoya-shi Aichi-ken (JP); Hiroki AWANO, Susono-shi Shizuoka-ken (JP); Kazuya KUMAZAWA, Nagoya-shi Aichi-ken (JP); Seigo FUJISHIMA, Miyoshi-shi Aichi-ken (JP); Tomohiro INAGAKI, Okazaki-shi Aichi-ken (JP)

(73) Assignee: TOYOTA JIDOSHA KABUSHIKI KAISHA, Toyota-shi Aichi-ken (JP)

(21) Appl. No.: 18/829,656

(22) Filed: Sep. 10, 2024

(30) Foreign Application Priority Data
Sep. 13, 2023 (JP) 2023-148296

(51) Int. Cl. H01M 50/609; H01M 50/103; H01M 50/531

(52) U.S. Cl. CPC H01M 50/609; H01M 50/103; H01M 50/531

(57) ABSTRACT

A power storage cell includes a case, an electrode assembly, and an electrolyte solution. The case houses the electrode assembly and the electrolyte solution. The case has a first bottom wall, a peripheral wall, and a second bottom wall. The second bottom wall faces the first bottom wall. The peripheral wall connects the first bottom wall and the second bottom wall. The peripheral wall includes a pair of main walls and a pair of side walls. The pair of side walls connect the pair of main walls. Each of the pair of main walls has a larger area than an area of each of the pair of side walls. A groove is formed in a surface of at least one of the pair of side walls in the case. The groove extends in a direction from the first bottom wall toward the second bottom wall.

### CROSS REFERENCE TO RELATED APPLICATIONS

This nonprovisional application is based on Japanese Patent Application No. 2023-148296 filed on Sep. 13, 2023 with the Japan Patent Office, the entire contents of which are hereby incorporated by reference.

### BACKGROUND

### Field

The present disclosure relates to a power storage cell.

### Description of the Background Art

JP-A-2009-301892 discloses a porous material surrounding an electrode assembly.

### SUMMARY

It has been proposed to dispose a porous material around an electrode assembly in a case. The electrolyte solution can permeate the porous member. With the porous member being disposed, it is expected to improve ease of injection. However, since the porous material reduces a space for housing the electrode assembly, the energy density of the power storage cell may be decreased.

It is an object of the present disclosure to improve the ease of injection.
1. A power storage cell according to one aspect of the present disclosure includes, for example, the following configuration. The power storage cell includes a case, an electrode assembly, and an electrolyte solution. The case houses the electrode assembly and the electrolyte solution. The case has a first bottom wall, a peripheral wall, and a second bottom wall. The second bottom wall faces the first bottom wall. The peripheral wall connects the first bottom wall and the second bottom wall. The peripheral wall includes a pair of main walls and a pair of side walls. The pair of main walls face each other. The pair of side walls face each other. The pair of side walls connect the pair of main walls. Each of the pair of main walls has a larger area than an area of each of the pair of side walls. A groove is formed in a surface of at least one of the pair of side walls in the case. The groove extends in a direction from the first bottom wall toward the second bottom wall.

Each of the main walls of the case can be in close contact with the electrode assembly. On the other hand, a space is likely to be formed between a side wall of the case and the electrode assembly. The space can serve as a flow path for the electrolyte solution. The groove is formed in the surface of the side wall. It is expected that the flow of the electrolyte solution is promoted by permeation of the electrolyte solution into the groove due to a capillary action. That is, improvement of the ease of injection is expected. Further, since the groove is formed in the surface of the case, it is considered that the groove is less likely to affect the space for housing the electrode assembly.
2. The power storage cell according to “1” may include, for example, the following configuration. The power storage cell further includes a current collecting member and an external terminal. The case is provided with the external terminal. The current collecting member connects the electrode assembly and the external terminal. At least a portion of the current collecting member is disposed between at least one of the pair of side walls and the electrode assembly.

Since the current collecting member is disposed between the side wall of the case and the electrode assembly, the energy density of the power storage cell is expected to be improved.
3. The power storage cell according to “1” or “2” may include, for example, the following configuration. A surface of each of the pair of main walls is flat in the case.

The fact that the surface of the main wall is flat means that there is no groove in the main wall. Since the main wall is flat, the main wall and the electrode assembly can be in close contact with each other. For example, when the main wall is pressed by a restraint member, an appropriate degree of surface pressure is expected to be applied to the electrode assembly.
4. A power storage cell according to one aspect of the present disclosure includes, for example, the following configuration. The power storage cell includes a case, an electrode assembly, an electrolyte solution, a current collecting member, and an external terminal. The case houses the electrode assembly and the electrolyte solution. The case has a first bottom wall, a peripheral wall, and a second bottom wall. The second bottom wall faces the first bottom wall. The peripheral wall connects the first bottom wall and the second bottom wall. The peripheral wall includes a pair of main walls and a pair of side walls. The pair of main walls face each other. The pair of side walls face each other. The pair of side walls connect the pair of main walls. Each of the pair of main walls has a larger area than an area of each of the pair of side walls. A groove is formed in a surface of at least one of the pair of side walls in the case. The groove extends in a direction from the first bottom wall toward the second bottom wall. A surface of each of the pair of main walls is flat in the case. The current collecting member connects the electrode assembly and the external terminal. At least a portion of the current collecting member is disposed between at least one of the pair of side walls and the electrode assembly.

Hereinafter, an embodiment (hereinafter, simply referred to as “the present embodiment”) of the present disclosure will be described. It should be noted that the present embodiment does not limit the technical scope of the present disclosure. The present embodiment are illustrative in any respects. The present embodiment is non-restrictive. The technical scope of the present disclosure includes any modifications within the scope and meaning equivalent to the terms of the claims. For example, it is initially expected to extract freely configurations from the present embodiment and combine them freely.

Geometric terms should not be interpreted in a strict sense. Examples of the geometric terms include “parallel”, “perpendicular”, and “orthogonal”. For example, the term “parallel” may be deviated to some extent from the strict definition of the term “parallel”. The geometric terms can include, for example, a tolerance, an error, and the like in terms of design, operation, manufacturing, and the like. A dimensional relation in each of the figures may not coincide with an actual dimensional relation. In order to facilitate understanding of the reader, the dimensional relation in each figure may be changed. For example, length, width, thickness, or the like may be changed. Further, part of configurations may be omitted.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic perspective view showing an example of a power storage cell according to the present embodiment.

FIG. 2 is a first schematic cross-sectional view showing an example of a power storage cell according to the present embodiment.

FIG. 3 is a second schematic cross-sectional view showing an example of the power storage cell according to the present embodiment.

FIG. 4 is a schematic cross-sectional view illustrating an example of an electrode assembly according to the present embodiment.

### DESCRIPTION OF THE EMBODIMENTS

### 1. Power Storage Cell

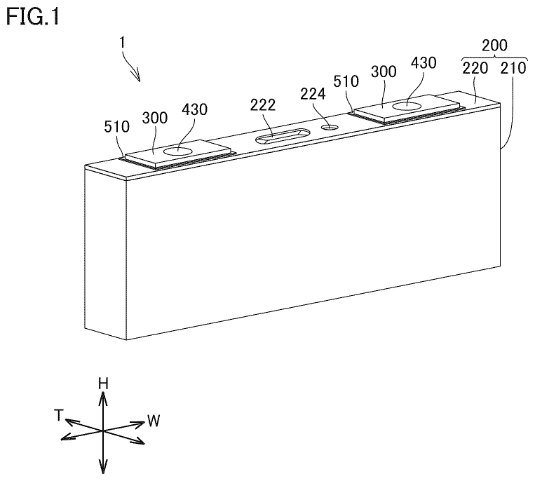

FIG. 1 is a schematic perspective view showing an example of a power storage cell according to the present embodiment. The power storage cell 1 may have, for example, a height direction, a width direction, and a thickness direction. The height direction, the width direction, and the thickness direction are orthogonal to each other. The “height direction” is the H direction in FIG. 1 and the like. The “width direction” is the W direction in FIG. 1 and the like. The “thickness direction” is the T direction in FIG. 1 and the like. The height direction may be parallel to the vertical direction, for example. The width direction and the thickness direction may be parallel to the horizontal direction, for example. The “height” indicates the dimension in the height direction. The “width” indicates a dimension in the width direction. The term “thickness” refers to the dimension in the thickness direction or the thickness of an object.

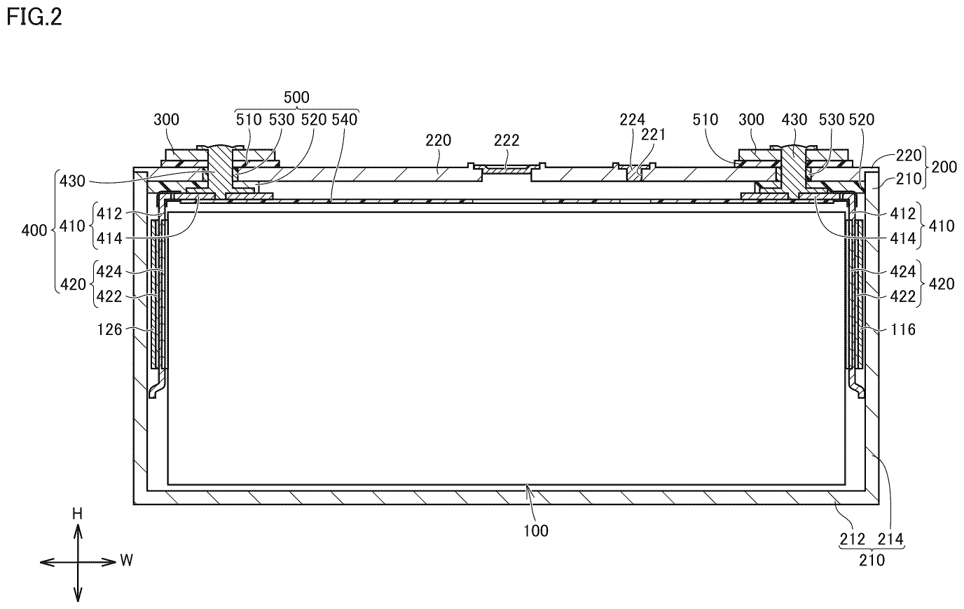

FIG. 2 is a first schematic cross-sectional view showing an example of a power storage cell according to the present embodiment. FIG. 2 shows a cross section perpendicular to the T direction. The power storage cell 1 includes a case 200, an electrode assembly 100, and an electrolyte solution (not shown). The electrolyte solution is a liquid electrolyte. The electrolyte solution may contain, for example, an organic solvent and a lithium salt.

### 2. Case

The case 200 houses the electrolyte solution and the electrode assembly 100. The case 200 may be hermetically sealed. The case 200 may be sealed. The case 200 may be a single piece. The case 200 may include a plurality of members. The case 200 may include, for example, a container 210 and a lid 220. The container 210 has an opening. The opening is open in the H direction. The opening may be opened vertically upward, for example. The container 210 may be made of metal, for example. The container 210 may include, for example, Al or the like. The container 210 may include, for example, a second bottom wall 212 and a peripheral wall 214. The second bottom wall 212 may have, for example, a flat plate shape. The planar shape of the second bottom wall 212 may be, for example, rectangular. The peripheral wall 214 stands from the second bottom wall 212. The peripheral wall 214 may have, for example, a quadrangular tubular shape. The width of the peripheral wall 214 may be greater than the thickness of the peripheral wall 214. The height of the peripheral wall 214 may be greater than the thickness of the peripheral wall 214. Here, the “thickness of the peripheral wall 214” indicates the outer dimension of the case 200 in the T direction.

The lid 220 closes the opening of the container 210. The lid 220 constitutes a first bottom wall. The second bottom wall 212 faces the first bottom wall (the lid 220). The peripheral wall 214 connects the first bottom wall and the second bottom wall 212. For example, the peripheral wall 214 may be welded to the lid 220. The lid 220 may have, for example, a flat plate shape. The lid 220 may be made of metal, for example. The lid 220 may include, for example, Al or the like. The lid 220 may include, for example, a pressure-release valve 222 and a sealing member 224.

The pressure-release valve 222 may be located, for example, near the center of the lid 220. The pressure-release valve 222 releases the internal pressure of the case 200. Once the internal pressure becomes equal to or more than the setting value, the pressure-release valve 222 may be opened. The sealing member 224 seals the injection hole 221. The electrolyte solution may be injected through the injection hole 221.

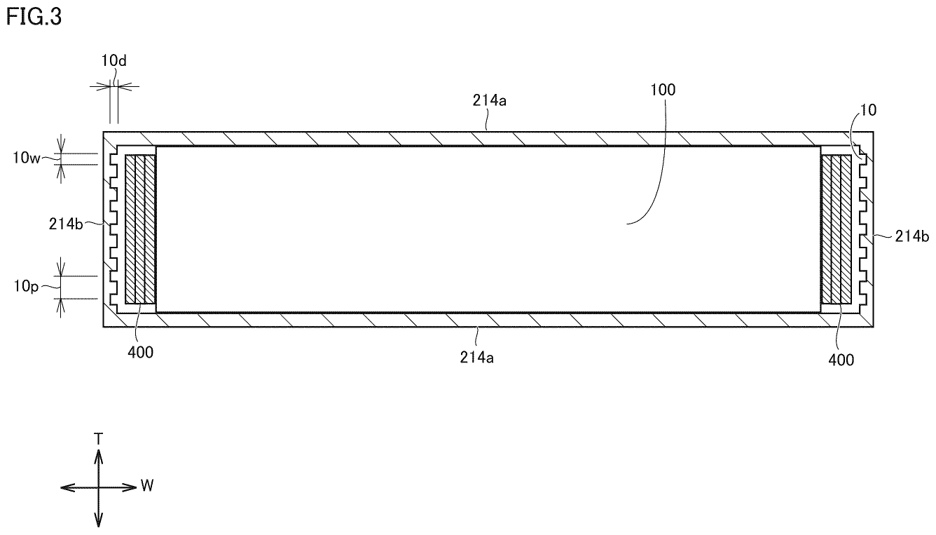

FIG. 3 is a second schematic cross-sectional view showing an example of the power storage cell according to the present embodiment. FIG. 3 shows a cross section perpendicular to the H direction. The peripheral wall 214 includes a pair of main walls 214a and a pair of side walls 214b. The pair of main walls 214a face each other. The pair of side walls 214b face each other. The pair of side walls 214b connects the pair of main walls 214a. The main wall 214a has a larger area than the side wall 214b. In the case 200, the groove 10 is formed in a surface of at least one of the pair of side walls 214b. The groove 10 may be formed on the surface of each of the pair of side walls 214b. The groove 10 may be formed in the surface of one of the pair of side walls 214b.

The groove 10 extends in the H direction along the surface of the side wall 214b. That is, the groove 10 extends in a direction from the first bottom wall (the lid 220) toward the second bottom wall 212. Alternatively, the groove 10 extends in a direction from the second bottom wall 212 toward the first bottom wall. The groove 10 may extend from the first bottom wall to the second bottom wall 212. The groove 10 may extend continuously. The groove 10 may extend intermittently. The groove 10 can be formed by, for example, cutting, laser processing, or the like.

The groove 10 may also be formed on the surface of the main wall 214a. The surface of the main wall 214a may be flat.

The groove 10 may be a single groove or a plurality of grooves. The plurality of grooves 10 may extend in parallel to each other. Each of the plurality of grooves 10 may extend linearly, for example.

The groove 10 may have any cross-sectional shape. The cross-sectional shape of the groove 10 may be, for example, a V-shape, a U-shape, a rectangular shape, a trapezoidal shape, or the like. The width 10w of the groove 10 may be, for example, 10 to 1000 μm, 100 to 500 μm, or 300 to 500 μm. The ratio of the depth 10d of the groove 10 to the thickness of the side wall 214b may be, for example, 0.1 to 0.9 or 0.3 to 0.7. The pitch 10p between adjacent grooves 10 may be, for example, 0.1 to 10 mm. The shapes and sizes of the plurality of grooves 10 may all be the same or may be different from each other.

### 3. Electrode Assembly

The electrode assembly 100 may have, for example, a cubic outer shape. The electrode assembly 100 may have, for example, a rectangular parallelepiped outer shape. The electrode assembly 100 may have, for example, a flat rectangular parallelepiped shape. The electrode assembly 100 may be covered with, for example, an insulating film (not illustrated).

The “first aspect ratio” indicates the ratio of the width to the height in the electrode assembly 100. The first aspect ratio may be, for example, 1 or more, 1.5 or more, 2 or more, 2.5 or more, 3 or more, 5 or more, or 10 or more. The first aspect ratio may be, for example, 10 or less, 5 or less, 3 or less, 2.5 or less, 2 or less, or 1.5 or less. The “second aspect ratio” indicates the ratio of the thickness to the height in the electrode assembly 100. The second aspect ratio may be, for example, 0.1 or more, 0.2 or more, 0.3 or more, 0.5 or more, or 1 or more. The second aspect ratio may be, for example, 1 or less, 0.5 or less, 0.3 or less, or 0.2 or less.

The electrode assembly 100 may have any structure. The electrode assembly 100 may be, for example, a wound type. The electrode assembly 100 may be, for example, a stacked type.

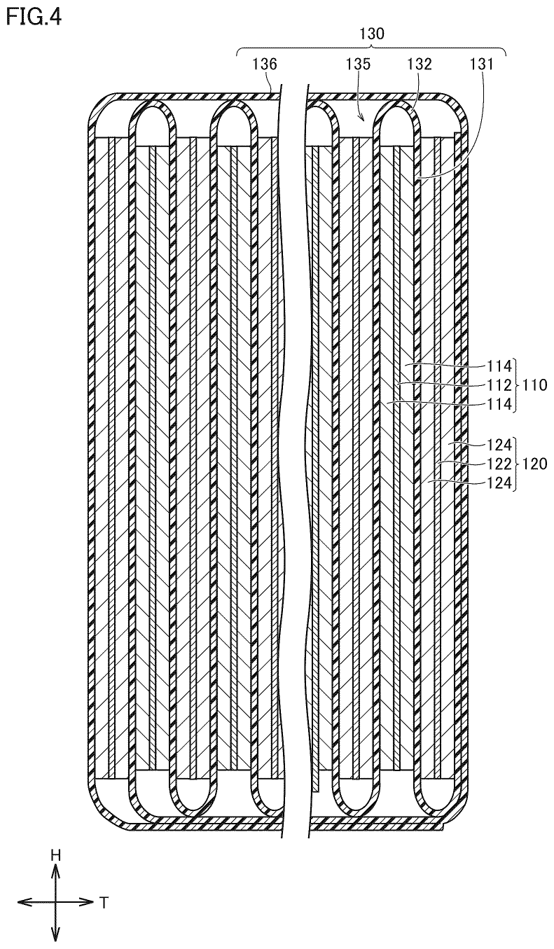

FIG. 4 is a schematic cross-sectional view illustrating an example of an electrode assembly according to the present embodiment. The electrode assembly 100 in FIG. 4 is a stacked type. The electrode assembly 100 includes one or more first electrodes 110, one or more second electrodes 120, and one or more separators 130. In the T direction, the first electrodes 110 and the second electrodes 120 are alternately stacked. That is, the T direction of the power storage cell 1 is parallel to the stacking direction of the first electrode 110 and the second electrode 120. Each of the numbers of the first electrodes 110 and the second electrodes 120 may be 2 or more, 5 or more, 10 or more, 50 or more, or 100 or more. Each of the numbers of the first electrodes 110 and the second electrodes 120 may be 200 or less, 100 or less, 50 or less, 10 or less, or 5 or less.

The second electrode 120 has a polarity different from that of the first electrode 110. For example, the first electrode 110 may be a positive electrode, and the second electrode 120 may be a negative electrode. For example, the first electrode 110 may be a negative electrode, and the second electrode 120 may be a positive electrode.

The first electrode 110 may include, for example, a first current collector 112 and a first active material layer 114. The first current collector 112 may include, for example, a metal foil or the like. The metal foil may contain, for example, Al, Cu, Ni, Ti, Fe, or the like. The first active material layer 114 is disposed on the surface of the first current collector 112. The first active material layer 114 may be disposed on only one surface of the first current collector 112. The first active material layer 114 may be disposed on both surfaces of the first current collector 112. The first active material layer 114 includes a positive electrode active material or a negative electrode active material. The positive electrode active material may include, for example, a lithium-nickel composite oxide or the like. The negative electrode active material may contain, for example, graphite, SiO, Si, or the like.

The second electrode 120 may include, for example, a second current collector 122 and a second active material layer 124. The second current collector 122 may include, for example, a metal foil or the like. The second active material layer 124 is disposed on the surface of the second current collector 122. The second active material layer 124 may be disposed on only one surface of the second current collector 122. The second active material layer 124 may be disposed on both surfaces of the second current collector 122. The second active material layer 124 includes a positive electrode active material or a negative electrode active material. The area of the second active material layer 124 may be the same as or different from that of the first active material layer 114. For example, the area of the second active material layer 124 may be larger than the area of the first active material layer 114. The ratio of the area of the second active material layer 124 to the area of the first active material layer 114 may be, for example, 1.01 or more, 1.05 or more, or 1.1 or more. The ratio of the area of the second active material layer 124 to the area of the first active material layer 114 may be, for example, 1.1 or less, 1.05 or less, or 1.01 or less.

The separator 130 has electrical insulation properties. The separator 130 is porous. The separator 130 may include, for example, a microporous polyolefin film or the like. The thickness of the separator 130 may be, for example, 5 to 50 μm, 5 to 30 μm, or 5 to 15 μm. The separator 130 separates the first electrode 110 from the second electrode 120. For example, two or more separators 130 may be provided. For example, one separator 130 may be inserted in each of portions between the first electrode 110 and the second electrode 120.

For example, one separator 130 may be provided. For example, separator 130 may include meandering portion 135. In the meandering portion 135, the separator 130 is folded into a meandering shape. The meandering shape may be expressed as, for example, a bellows shape, an accordion shape, or the like.

The meandering portion 135 includes a planar portion 131 and a folded portion 132. In the planar portion 131, the separator 130 extends in a planar shape. In the folded portion 132, the separator 130 is folded back. The folded portions 132 are disposed at both ends in the H direction. The separator 130 is folded so as to alternately sandwich the first electrode 110 or the second electrode 120. The planar portion 131 sandwiches the first electrode 110 or the second electrode 120. Separator 130 may further include, for example, an outer peripheral portion 136. The outer peripheral portion 136 may be wound so as to wrap around the meandering portion 135. The separator 130 may be folded back at both ends in the W direction to form a meandering portion.

### 4. Others

The power storage cell 1 further includes an external terminal 300. The pair of external terminals 300 is fixed to the lid 220. The external terminal 300 is connected to the first electrode 110 or the second electrode 120. The external terminal 300 may be made of metal, for example. The external terminal may include Al, Cu, Ni, or the like. The external terminal 300 may have, for example, a rectangular parallelepiped outer shape. The external terminal 300 may be connected to a bus bar (not shown).

The power storage cell 1 further includes a current collecting member. The coupling member 400 constitutes a current collecting member. The pair of coupling members 400 connects the electrode tab (electrode assembly 100) and the external terminal 300. The electrode tab indicates the first electrode tab 116 or the second electrode tab 126. The two coupling members 400 may have substantially the same structure.

The coupling member 400 may include, for example, a current collecting tab 410, a sub-tab 420, and a coupling pin 430. The sub-tab 420 is disposed between the side wall 214b and the electrode assembly 100. That is, at least a part of the current collecting member is disposed between at least one of the pair of side walls 214b and the electrode assembly 100. The current collecting tab 410 includes a side portion 412 and an upper portion 414. The side portion 412 is located on the side of the electrode assembly 100 in the W direction. The upper portion 414 is located above the electrode assembly 100. The upper portion 414 extends inward in the W direction from the upper end of the side portion 412.

Sub-tab 420 connects the plurality of electrode tabs to current collecting tab 410. The sub-tab 420 may include a first end portion 422 and a second end portion 424. The first end portion 422 is connected to the plurality of electrode tabs. The second end portion 424 is connected to the side portion 412.

The coupling pin 430 connects the current collecting tab 410 to the external terminal 300. The coupling pin 430 couples the upper portion 414 and the external terminal 300. For example, the lower end portion of the coupling pin 430 may be inserted into a through hole provided in the upper portion 414.

The insulating member 500 insulates the case 200 from the coupling member 400. The insulating member 500 may include, for example, a first portion 510, a second portion 520, a third portion 530, and a fourth portion 540.

The first portion 510 is fixed to the upper surface of the lid 220. The first portion 510 is disposed between the lid 220 and the external terminal 300. The second portion 520 is fixed to the lower surface of the lid 220. The second portion 520 is disposed between the lid 220 and the upper portion 414. The second portion 520 is disposed between the lid 220 and the lower portion of the coupling pin 430. The third portion 530 is disposed between the coupling pin 430 and the lid 220. The third portion 530 has a tubular shape. The third portion 530 surrounds the coupling pin 430. The first portion 510, the second portion 520, and the third portion 530 are provided with through holes. The coupling pin 430 is inserted through the through hole.

The fourth portion 540 has a plate shape. It is fixed to the lower surface of the upper portion 414. The fourth portion 540 is disposed above the electrode assembly 100. In the fourth portion 540, a through hole is provided below the pressure-release valve 222. In the fourth portion 540, a through hole is also provided below the injection hole 221.

What is claimed is:

1. A power storage cell comprising:
a case;
an electrode assembly; and
an electrolyte solution, wherein
the case houses the electrode assembly and the electrolyte solution,
the case has a first bottom wall, a peripheral wall, and a second bottom wall,
the second bottom wall faces the first bottom wall,
the peripheral wall connects the first bottom wall and the second bottom wall,
the peripheral wall includes a pair of main walls and a pair of side walls,
the pair of main walls face each other,
the pair of side walls face each other,
the pair of side walls connect the pair of main walls,
each of the pair of main walls has a larger area than an area of each of the pair of side walls,
a groove is formed in a surface of at least one of the pair of side walls in the case, and
the groove extends in a direction from the first bottom wall toward the second bottom wall.

2. The power storage cell according to claim 1, further comprising:
a current collecting member; and
an external terminal, wherein
the case is provided with the external terminal,
the current collecting member connects the electrode assembly and the external terminal, and
at least a portion of the current collecting member is disposed between at least one of the pair of side walls and the electrode assembly.

3. The power storage cell according to claim 1, wherein a surface of each of the pair of main walls is flat in the case.

4. A power storage cell comprising:
a case;
an electrode assembly;
an electrolyte solution;
a current collecting member; and
an external terminal, wherein
the case houses the electrode assembly and the electrolyte solution,
the case has a first bottom wall, a peripheral wall, and a second bottom wall,
the second bottom wall faces the first bottom wall,
the peripheral wall connects the first bottom wall and the second bottom wall,
the peripheral wall includes a pair of main walls and a pair of side walls,
the pair of main walls face each other,
the pair of side walls face each other,
the pair of side walls connect the pair of main walls,
each of the pair of main walls has a larger area than an area of each of the pair of side walls,
a groove is formed in a surface of at least one of the pair of side walls in the case,
the groove extends in a direction from the first bottom wall toward the second bottom wall,
a surface of each of the pair of main walls is flat in the case,
the current collecting member connects the electrode assembly and the external terminal, and
at least a portion of the current collecting member is disposed between at least one of the pair of side walls and the electrode assembly.
